(19) United States
(12) Patent Application Publication
(10) Pub. No.: US 2006/0085787 A1
(43) Pub. Date: Apr. 20, 2006

(54) Method for providing a rapid response to an application launch request

(75) Inventor: Nigel Breslaw, Oulu (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/941,595

(22) Filed: Sep. 15, 2004

(51) Int. Cl. G06F 9/46

(52) U.S. Cl. 718/100

(57) ABSTRACT

A method, computer program product, and device provide a rapid response to a request to launch an application. The device includes a memory manager application, a memory, and a processor. The memory manager application is configured to receive a request to launch an application; to switch to the application, if the application is open; if the application is not open, to determine if sufficient memory is available to launch the application; if the application is not open and sufficient memory is available, to launch the application; if sufficient memory is not available, to identify a lowest ranking open application from one or more open application using a lowest usage ranking; and if sufficient memory is not available, to close the lowest ranking open application.

### FIELD OF THE INVENTION

The present invention relates generally to the field of computer systems, software, and methods of monitoring application usage and of managing the computer system memory.

### BACKGROUND OF THE INVENTION

A program or application provides computing devices with the capability to perform a wide variety of tasks including drafting documents, communicating with others, preparing presentations, creating movies and music, etc. A program or application is an organized list of instructions that, when executed, cause the computer to behave in a predetermined manner. The instructions may be written using one or more programming languages. High level programming languages include C, C++, Pascal, BASIC, FORTRAN, COBOL, and LISP. Programs can also be written in low-level languages called assembly languages that or scripting languages that do not require assembly and compilation prior to execution. The term “execution” is the process of running a program or the carrying out of the operation called for by an instruction. A computer processor executes an instruction, meaning that it performs the operations called for by that instruction. For a program to execute, the program must be translated into a machine language that the computer can understand. The machine language is generally compiled into an executable. Purchased software normally comes in a form that is ready for execution by a particular computer system or device. Whenever a file is accessed (that is, a text file is edited or a program file is run), the operating system opens the file.

A user executes an application by selecting the application for launch. Launching the application generally requires retrieving the executable from a permanent memory device and copying the executable to a temporary memory device. The temporary memory device is generally some form of random access memory (RAM). The RAM or system memory holds the operating system and application programs and data in current use so that they can be reached quickly by the computer's processor. RAM is much faster to read from and write to than permanent memory devices such as a hard disk, a floppy disk, a CD-ROM, etc. However, the data in RAM is volatile meaning that it stays there only as long as the computer is turned on. When the computer is turned off, RAM loses its data.

There are two basic types of RAM: dynamic RAM (DRAM) and static RAM (SRAM). The two types differ in the technology they use to hold data, DRAM being the more common type. DRAM needs to be refreshed thousands of times per second. SRAM does not need to be refreshed, making it faster; but it is also more expensive than DRAM. SRAM holds its data without external refresh, for as long as power is supplied to the circuit; whereas, DRAM must be refreshed many times per second in order to hold its data contents.

ROM (read-only memory) refers to special memory used to store programs that boot the computer and perform diagnostics. Most computers have a small amount of ROM (a few thousand bytes). The values stored in ROM are always there, whether the power is on or not. A ROM can be removed from the computer, stored for an indefinite period of time, and then replaced, and the data it contains will still be there. For this reason, it is called non-volatile storage. A hard disk is also non-volatile, for the same reason, but regular RAM is not. ROM is most commonly used to store system-level programs that must be available to the computer at all times. The most common example is the system Basic Input Output System (BIOS) program.

Every computer has a hardware logic circuit called the memory controller that controls the memory. It generates the necessary signals to control the reading and writing of information from and to the memory, and interfaces the memory with the other major parts of the system. The memory controller is normally integrated into the system chipset.

One problem concerning current computing devices is the time required to launch an application. Processors have continually increased in speed, but with that increase in speed have come larger and larger applications that require both more permanent memory for storage and more temporary memory for execution. As a result, a user must wait a period of time while a computer system launches an application and opens it for use in temporary memory. Additionally, the increasing proliferation of hand-held devices including cellular telephones, Personal Data Assistants (PDAs), and Integrated Messaging Devices (IMDs) has provided an increasing desire for more computing power in ever smaller packages. Users, in their ever more hectic lives, demand near instantaneous response when they select an application for launch. Applications in modern hand held devices may require from microseconds to several seconds to launch and to open for use by a user.

U.S. Pat. No. 6,324,546 provides a method for improving performance by organizing applications in memory devices so that often used applications are stored in areas of memory that are faster to access or otherwise have less effect on performance. The operating system records certain information every time an application is used. This information is used to reorganize how application programs are stored in a memory device. This method may improve the time required to launch, but there is still a need for further reduced response times particularly relative to hand held devices.

The patent application publication Serial No. 2003/0056076 provides a memory management system that closes applications when memory is needed based on a priority. This priority, however, is not based on the frequency of use of an application.

Consequently, a need exists for systems and methods that provide a rapid response to a request to launch an application. There is a further need for systems and methods that avoid re-launching often used applications.

### SUMMARY OF THE INVENTION

One exemplary embodiment of the invention relates to a method of responding to a request to launch an application. The method includes, but is not limited to, receiving a request to launch an application; switching to the application, if the application is open; if the application is not open, determining if sufficient memory is available to launch the application; if the application is not open and sufficient memory is available, launching the application; if sufficient memory is not available, identifying a lowest ranking open application from one or more open application using a lowest usage ranking; and if sufficient memory is not available, closing the lowest ranking open application.

Another exemplary embodiment of the invention relates to a computer program product for responding to a request to launch an application. The computer program product includes, but is not limited to, computer code configured to receive a request to launch an application; to switch to the application, if the application is open; if the application is not open, to determine if sufficient memory is available to launch the application; if the application is not open and sufficient memory is available, to launch the application; if sufficient memory is not available, to identify a lowest ranking open application from one or more open application using a lowest usage ranking; and if sufficient memory is not available, to close the lowest ranking open application.

Another exemplary embodiment of the invention relates to a device for responding to a request to launch an application. The device comprises a memory manager application, a memory, and a processor. The memory manager application includes, but is not limited to, computer code configured to receive a request to launch an application; to switch to the application, if the application is open; if the application is not open, to determine if sufficient memory is available to launch the application; if the application is not open and sufficient memory is available, to launch the application; if sufficient memory is not available, to identify a lowest ranking open application from one or more open application using a lowest usage ranking; and if sufficient memory is not available, to close the lowest ranking open application. The memory stores the memory manager application. The processor couples to the memory and is configured to execute the memory manager application.

Other principal features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, wherein like numerals will denote like elements.

FIG. 1 is a diagrammatic representation of a system in accordance with an exemplary embodiment.

FIG. 2 is a flow diagram depicting operations in a system providing a rapid response to a request to launch an application in accordance with an exemplary embodiment.

FIG. 3 is a diagram of a database structure for recording usage information for applications in accordance with an exemplary embodiment.

FIG. 4 is a flow diagram depicting operations supporting maintenance of the database structure of FIG. 3 in accordance with an exemplary embodiment.

FIG. 5 is a flow diagram depicting operations in a system providing a rapid response to a request to launch an application in accordance with an alternative embodiment.

### DETAILED DESCRIPTION OF THE INVENTION

The invention can be practiced with computer system configurations including, without limitation, cellular telephones, PDAs, such as those manufactured by PALM, Inc., IMDs, such as those manufactured by Blackberry, Inc., and other hand-held devices; notebook computers; laptop computers; mainframe computers, multi-processor systems, etc. Program modules can be located in both local and remote memory storage devices.

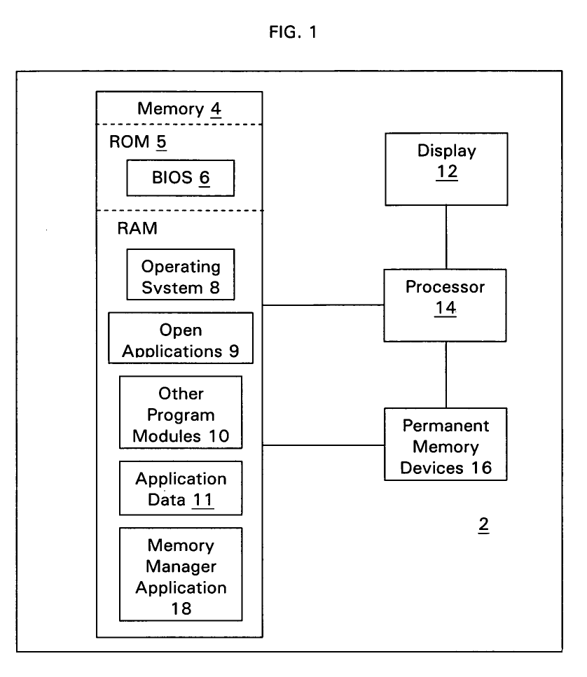

FIG. 1 illustrates a system 2, in accordance with an exemplary embodiment, comprising a display 12, a processor 14, permanent memory devices 16, and a memory 4. The display 12 presents application information to the user possibly including a user interface created by executing applications. The display 12 can be a thin film transistor (TFT) display, a light emitting diode (LED) display, a Liquid Crystal Display (LCD), Cathode Ray Tube (CRT) display, or any of a variety of different displays known to those skilled in the art. The processor 14 executes open applications. Applications are open for execution after a user requests that the system 2 launch the application. Launching the application generally requires copying an executable for the application from a permanent memory device 16 to a temporary memory device that is generally some form of RAM 7. Permanent memory devices 16 include, without limitation, a hard disk (optical or magnetic), a floppy disk, a CD-ROM, a ZIP drive, a JAZ drive, a Digital Versatile Disk drive, a Multi Media Card, etc.

The memory 4 comprises both ROM 5 and RAM 7. ROM 5 is most commonly used to store system-level programs that must be available to the computer at all times. The most common example is the system BIOS program 6. The system BIOS program 6 usually provides low-level access to the computer's hardware and resides on a chip. The RAM 7, also commonly known as the system memory, holds information currently in use by the user including, without limitation, the operating system 8, application programs 9, other program modules 10, application data 11, and a memory manager application 18. The RAM 7 holds the currently used information so that the information can be reached quickly by the processor 14. RAM 7 is much faster to read from and write to than permanent memory devices 16.

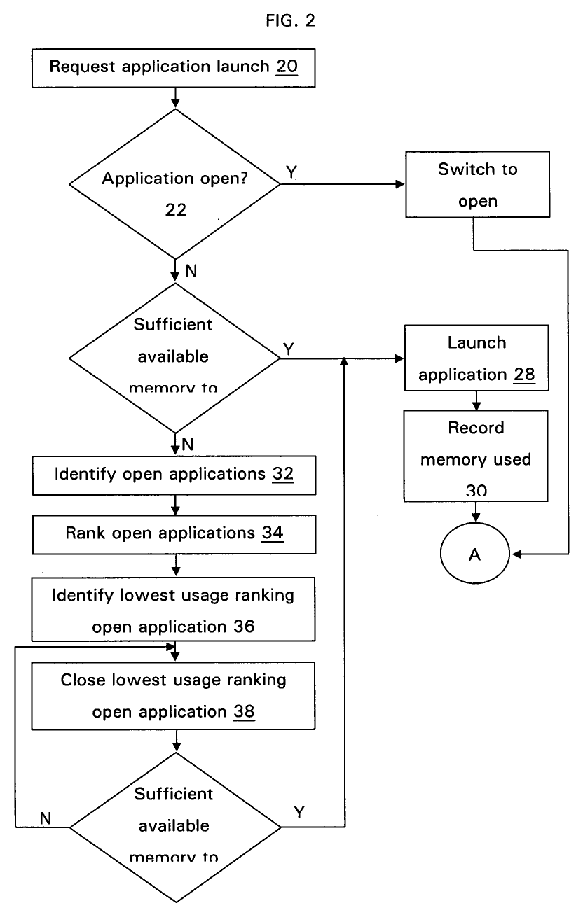

FIG. 2, in an exemplary embodiment, illustrates a flow diagram depicting operations of the memory manager application 18 that provides a rapid response to a request to launch an application. At operation 20, a user requests that the system 2 launch an application. The test at operation 22 determines if the requested application is already open or not. If the application is already open and, thus in memory 4, the processor 12, executing operating system instructions, switches to the already open requested application at operation 24. Because the application is already open, the launch of the requested application appears to be instantaneous to the user.

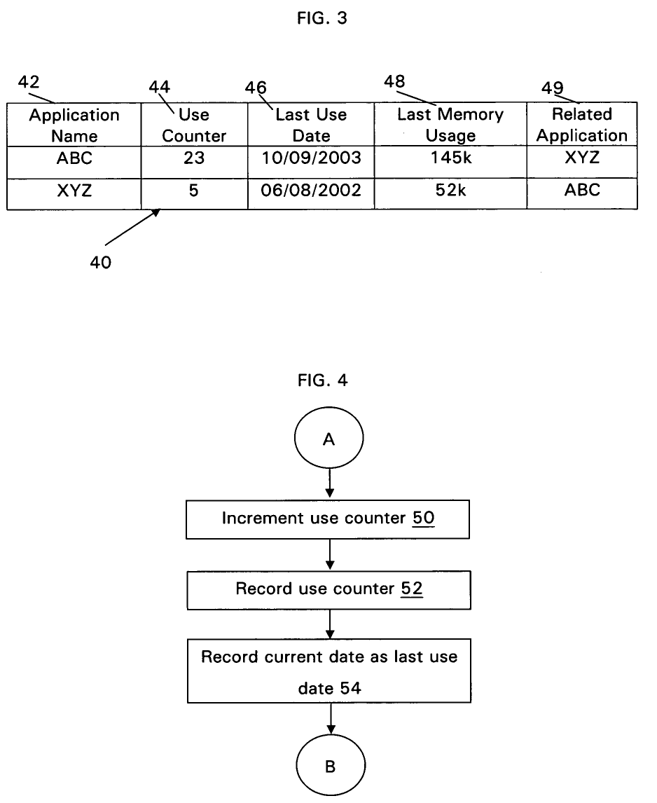

If the requested application is not open, the test at operation 26 determines if sufficient memory is available to launch the requested application. To perform the test, a last memory usage of the requested application is extracted from a memory management file. In an exemplary embodiment, the contents of a sample memory management file 40 are shown in FIG. 3. The memory management file 40 may be a database file, a text file, a spreadsheet, part of the registry, or any other mechanism for maintaining a record of information on a computer. Records in the memory management file 40 include an application name field 42, a use counter field 44 for the application, a last use date field 46 for the application, a last memory usage field 48 for the application, and a related application field 49.

The application name field 42 contains a unique application identifier. The use counter field 44 contains the total number of times that the application has been used. In an exemplary embodiment, the use counter field 44 is incremented each time the application is launched or switched to because the application was already open. The last use date field 46 indicates the last day that the application was used. In an exemplary embodiment, the last use date field 46 indicates the last day that the application was launched or switched to when already open. The last memory usage field 48 indicates the amount of memory 4 used by the application the last time the application was launched.

The related application field 49 includes the application name of any application that is frequently used at the same time that the requested application is used. Related applications may be identified initially in the application software based on common knowledge of application usage. For example, it is known that if a camera application is used then typically an images application or a messaging application is used immediately afterward to view and to edit the image or to send the image. Additionally, by logging the order in which applications are used, related applications can be determined for the user. Thus, the repetitive nature of certain tasks that may be specific to a user may result in two or three applications being repeatedly opened to complete a single user need. For example, the user may send a message and then set the alarm clock every evening to wake up at a certain time the next morning.

As shown in FIG. 4 at operation 50, after the requested application is switched to (or launched as shown in FIG. 2), the use counter field 44 of the memory management file 40 is incremented. The new value of the use counter field 44 is recorded in the corresponding field of the memory management file 40 at operation 52. Thus, the memory management file 40 is updated with the new use counter value and saved. The last use date 46 field is also updated and recorded with the current date at operation 54.

The last memory usage of the requested application is extracted from the memory management file last memory usage field 48 for the requested application. As applications are used, the memory usage may change. For example, an address book may acquire more entries with time requiring more memory to open. Thus, each time the application is launched, the last memory usage field 48 is updated with the memory required to execute the application as shown in FIG. 2 at operation 30. To determine if sufficient memory is available to launch the requested application, the system determines the available system memory. The available system memory is generally known at all times by the processor 14. The available system memory is compared to the last memory usage of the requested application that was extracted from the memory management file last memory usage field 48. If the available system memory is greater than or equal to the last memory usage of the requested application, sufficient memory is available. If sufficient memory is available as determined at operation 26 in FIG. 2, the application is launched at operation 28. As related previously, the memory management fields 44, 46, and 48 are updated and recorded to the memory management file 40 whenever the requested application is launched.

If sufficient memory is not available, the memory manager application 18 identifies all open applications at operation 32. The identified open applications are ranked at operation 34. Ranking the open applications may utilize the memory management file use counter field 44 and/or the last use date field 46. Either of the use counter field 44 and the last use date field 46 may be used first with the other being used to decide ties between applications. At operation 36, the lowest ranking application is identified. The lowest ranking application in general will have the lowest use counter and/or the longest elapsed time since the last use date in comparison to the current date as compared the other open applications. A person skilled in the art will readily recognize that there are many well-known methods for identifying the lowest ranking open application at operation 36. For purposes of illustration only, the open applications may be sorted in increasing order by their respective use counter extracted from the memory management file 40. Secondarily within each use counter 44 value, the open applications may be sorted in decreasing order of elapsed time since the last use date 46 for the requested application. The first application in the sorted list would then be the lowest ranking open application. At operation 38, the lowest usage ranking open application is closed.

The test at operation 26 is then repeated to determine if sufficient memory is available to launch the requested application. If sufficient memory is not available, the next lowest ranking open application is then closed until there is sufficient memory available to launch the requested application at operation 28.

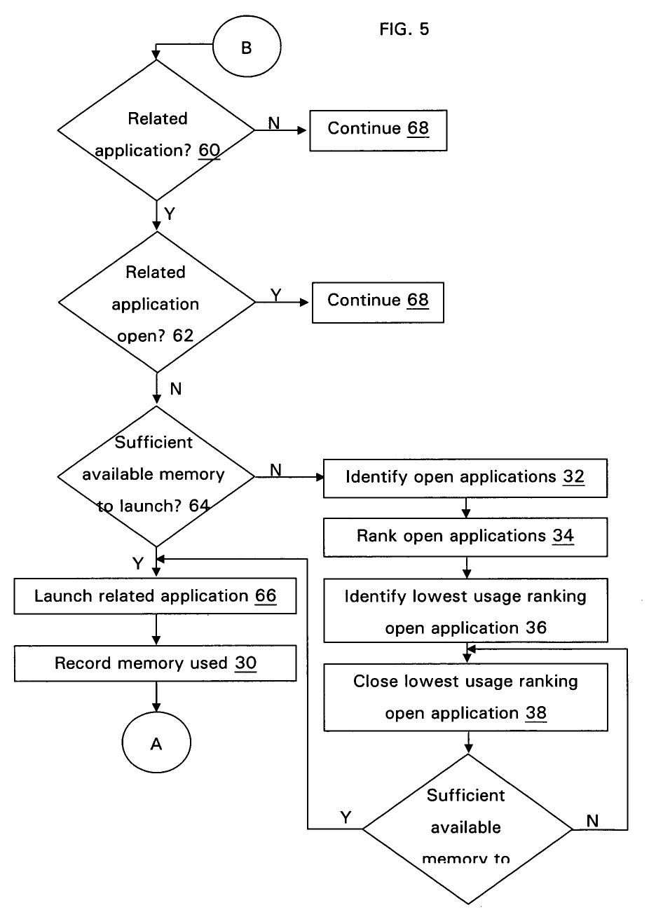

FIG. 5 is a flow diagram depicting operations in a system providing a rapid response to a request to launch an application in accordance with an alternative embodiment. The related application field 49 of the memory management file 40 may be empty, may hold a single application name, or may hold a list of application names where an application has multiple related applications. Related applications are those applications that are frequently used in combination with another application. To further improve response times for launching applications, a related application(s) may be launched with a requested application. At operation 60 as shown in FIG. 5, any related applications are determined using the memory management file 40 in an exemplary embodiment. If there are no related applications, processing continues at operation 68. If a related application is identified, the test at operation 62 determines if the related application(s) are already open in the background. If the related application is already open, processing continues at operation 68. If the related application is not already open, the processing is similar to that discussed relative to FIG. 2 except that, at operation 66, the related application is launched.

It is understood that the invention is not confined to the particular embodiments set forth herein as illustrative, but embraces all such modifications, combinations, and permutations as come within the scope of the following claims. The functionality described may be implemented in a single executable or application or may be distributed among modules that differ from those described herein without deviating from the spirit of the invention. Additionally, the order of execution of the functions may be changed without deviating from the spirit of the invention. Thus, the description of the exemplary embodiments is for purposes of illustration and not limitation.

What is claimed is:

1. A method of responding to a request to launch an application, the method comprising:
receiving a request to launch an application;
switching to the application, if the application is open;
if the application is not open, determining if sufficient memory is available to launch the application;
if the application is not open and sufficient memory is available, launching the application;
if sufficient memory is not available, identifying a lowest ranking open application from one or more open application; and
if sufficient memory is not available, closing the lowest ranking open application.

2. The method of claim 1, further comprising incrementing a use counter of the application.

3. The method of claim 2, further comprising recording the use counter of the application.

4. The method of claim 3, wherein identifying a lowest ranking open application from the one or more open application uses a lowest usage ranking.

5. The method of claim 4, wherein the lowest usage ranking is based on a use counter of the one or more open application.

6. The method of claim 1, further comprising recording a current date as a last use date of the application.

7. The method of claim 6, wherein identifying a lowest ranking open application from the one or more open application uses a lowest usage ranking.

8. The method of claim 7, wherein the lowest usage ranking is based on a last use date of the one or more open application.

9. The method of claim 1, further comprising recording a memory usage of the application.

10. The method of claim 9, wherein determining if sufficient memory is available comprises:
determining an available system memory;
comparing the memory usage of the application to the available system memory; and
if the available system memory is greater than or equal to the memory usage of the application, determining that sufficient memory is available.

11. The method of claim 1, further comprising launching a related application if sufficient memory is available and the related application is not open.

12. A computer program product for responding to a request to launch an application, the computer program product comprising:
computer code configured to:
receive a request to launch an application;
switch to the application, if the application is open;
if the application is not open, determine if sufficient memory is available to launch the application;
if the application is not open and sufficient memory is available, launch the application;
if sufficient memory is not available, identify a lowest ranking open application from one or more open application; and
if sufficient memory is not available, close the lowest ranking open application.

13. The computer program product of claim 12, wherein the computer code is further configured to increment a use counter of the application.

14. The computer program product of claim 13, wherein the computer code is further configured to record the use counter of the application.

15. The computer program product of claim 14, wherein the computer code configured to identify a lowest ranking open application from the one or more open application uses a lowest usage ranking.

16. The computer program product of claim 15, wherein the lowest usage ranking is based on a use counter of the one or more open application.

17. The computer program product of claim 12, wherein the computer code is further configured to record a current date as a last use date of the application.

18. The computer program product of claim 17, wherein the computer code configured to identify a lowest ranking open application from the one or more open application uses a lowest usage ranking.

19. The computer program product of claim 18, wherein the lowest usage ranking is based on a last use date of the one or more open application.

20. The computer program product of claim 12, wherein the computer code is further configured to record a memory usage of the application.

21. The computer program product of claim 20, wherein the computer code configured to determine if sufficient memory is available comprises computer code configured to:
determine an available system memory;
compare the memory usage of the application to the available system memory; and
if the available system memory is greater than or equal to the memory usage of the application, determine that sufficient memory is available.

22. The computer program product of claim 12, wherein the computer code is further configured to launch a related application if sufficient memory is available and the related application is not open.

23. A device for responding to a request to launch an application, the system comprising:
a memory manager application, the memory manager application comprising computer code configured to
receive a request to launch an application;
switch to the application, if the application is open;
if the application is not open, determine if sufficient memory is available to launch the application;
if the application is not open and sufficient memory is available, launch the application;
if sufficient memory is not available, identify a lowest ranking open application from one or more open application; and
if sufficient memory is not available, close the lowest ranking open application;
a memory, wherein the memory stores the memory manager application; and
a processor coupled to the memory, the processor configured to execute the memory manager application.

24. The device of claim 23, wherein the computer code is further configured to increment a use counter of the application.

25. The device of claim 24, wherein the computer code is further configured to record the use counter of the application.

26. The device of claim 25, wherein the computer code configured to identify a lowest ranking open application from the one or more open application uses a lowest usage ranking.

27. The device of claim 26, wherein the lowest usage ranking is based on a use counter of the one or more open application.

28. The device of claim 23, wherein the computer code is further configured to record a current date as a last use date of the application.

29. The device of claim 28, wherein the computer code configured to identify a lowest ranking open application from the one or more open application uses a lowest usage ranking.

30. The device of claim 29, wherein the lowest usage ranking is based on a last use date of the one or more open application.

31. The device of claim 23, wherein the computer code is further configured to record a memory usage of the application.

32. The device of claim 31, wherein the computer code configured to determine if sufficient memory is available comprises computer code configured to:
determine an available system memory;
compare the memory usage of the application to the available system memory; and
if the available system memory is greater than or equal to the memory usage of the application, determine that sufficient memory is available.

33. The device of claim 23, wherein the computer code is further configured to launch a related application if sufficient memory is available and the related application is not open.
